(19) United States
(12) Patent Application Publication
(10) Pub. No.: US 2002/0062526 A1
(43) Pub. Date: May 30, 2002

(54) Brake slack adjusting tool with socket section and tire tester

(75) Inventor: Raymond Alan Keldsen, Watsonville, CA (US)

Correspondence Address: CENTRAL COAST PATENT AGENCY, PO BOX 187, AROMAS, CA, 95004, US

(73) Assignee: KELDSEN

(21) Appl. No.: 09/727,966

(22) Filed: Nov. 30, 2000

(51) Int. Cl. B25F 1/00

(52) U.S. Cl. 7/100

(57) ABSTRACT

A tool for measuring and adjusting slack movement related to operating components of an air-brake assembly has an elongated lever portion for enabling leverage force to be applied to a rocker-arm component of the air-brake assembly, an abutment fixture fixedly attached to the first end of the lever portion, the abutment fixture providing a fulcrum point against the rocker-arm component for application of leverage force, and an engaging member fixedly attached to the first end of the lever portion at a point substantially inward from the attachment position of the abutment fixture. The engaging member is for engaging the rocker-arm component on an edge of the rocker-arm component opposite an edge engaged by the abutment fixture. A socket mount is fixedly attached to the second end of the lever portion at a position substantially inward of the outer edge of the second end, the socket comprising a socket for fitted engagement of a slack-adjustment nut of the air brake assembly. In one embodiment, the tool further includes an elongated impact head fixedly attached thereto the impact head for striking tires resulting in a determination of proper tire inflation.

### FIELD OF THE INVENTION

The present invention is in the field of vehicle brake adjustment tools, and has particular application in testing and adjusting slack in air brake systems and in checking tires for pressure.

### BACKGROUND OF THE INVENTION

A large vehicle such as a heavy truck used for carrying or pulling freight, or a bus used for transporting large numbers of people at the same time, must be equipped with a braking system that provides much greater stopping power than provided by a typical passenger vehicle, for instance. A truck tractor is a motor vehicle designed primarily for drawing truck trailers and constructed to carry part of the weight and load of a truck trailer equipped with one or more axles, or semi trailer, so constructed that the end and a substantial part of his own weight and that of its load rests upon a truck tractor. A full trailer is so constructed that all of its own weight and that of its load rests upon its own wheels. For instance, a truck tractor equipped with an engine capable of generating 400 horsepower, pulling a combined gross weight of 80,000 pounds may require up to approximately 1320 feet of distance to achieve a speed of 40 miles per hour. To conform to safety guidelines a braking system of such a vehicle should be able to stop the vehicle within a distance of approximately 133 feet with the mentioned speed and weight, equating to a stopping power approximately 10 times more powerful than the pulling power of the engine, a ratio much higher than a typical lighter vehicle.

Early truck braking systems, having a simple beginning consisting primarily of brake shoes operating directly on the wheels, have evolved into one of the most complex braking systems found on any type of vehicle. This is primarily due to be greatly increased stopping power and reliability required of the braking system. Heavy trucks such as previously described use air brakes almost exclusively. With the exception of some recently manufactured heavy truck models utilizing air-cooled disk-type brakes, the majority of heavy trucks utilize internally-expanding drum type systems utilizing an engine-driven air compressor supplying air to a chamber when the brakes are applied, forcing out a push rod connected to a slack adjuster which rotates a connected cam forcing internal brake shoes out against the inner wall of the brake drum to provide the stopping power.

Such a braking system is preferable for its reliability and performance under very extreme use and heavy loads, but because of the excessive wear often requires periodic maintenance or adjustment at intervals shorter than required for a passenger car for example, to maintain the desired level of reliability and performance. Brake shoes utilized in an internally expanding drum-type braking system are the components most subject to wear and adjustment. One cause of such wear is the friction between their outer surfaces and the inner wall of the brake drum when the brakes are applied, eventually wearing down the thickness of the brake shoe by loss of brake shoe material from the outer edge. In some cases, as brakes are applied and heat is generated by the conversion of kinetic energy to thermal energy by such friction as described, some of the glue within the brake shoe material may soften and partially melt causing the outer surface to become increasingly slick causing loss of friction and brake performance. This condition is commonly described as brake fading. Also, if the brakes of a heavy truck are applied moderately over an extended period of time, such as when, in order to maintain a safe speed, an operator applies the brakes continually while traveling a long downgrade, excessive heat will be generated causing the brake drum to expand, to a certain degree, away from the brake shoes and beyond the outer limits of its specification. A longer push rod stroke would then be required to achieve proper braking. If too much brake slack is created by this condition, or the conditions of break shoe wear or brake fade exist, a brake slack adjustment is most often necessary. In many cases, particularly during, or prior to and in preparation of, a long steady descent, an operator is required to stop the vehicle and perform an immediate brake adjustment to safely travel further.

A brake slack adjustment on an air brake system as described above is achieved by first determining the degree of slack by manually turning a rocker arm slack adjuster, usually using an extension tool designed for the purpose, and noting the distance traveled by the end of an adjusting arm while applying pressure. An internal worm gear mechanism within the rocker arm slack adjuster provides the necessary adjustment to a cam ultimately connected to a brake shoe push rod, and is actuated by manually turning a connected external, commonly hexagonal nut or similar connected member. By manually turning the nut in one direction the brake shoes are expanded outward towards the inner drum wall lessening the space between them while also shortening the required push rod stroke.

Turning of the adjustment nut requires the use of a separate tool, an open-end or socket wrench for example. A common brake slack adjustment has such an attached nut, but other slack adjusters of air brake systems in various truck models may use different sizes of nuts, or may use another type of common external adjustment member. Such a disparity presents a problem for many operators who perform such roadside brake slack adjustments as previously described, and also for mechanics who perform many air brake adjustments on different model trucks and other vehicles in a repair shop environment, for example. An operator, after determining a brake slack adjustment is necessary utilizing a bar-tool using the process previously described, must disengage the bar tool from the rocker arm slack adjuster, release the tool can grasp a socket wrench, for example, and perform the slack adjustment by turning the adjustment nut. If the adjustment nut to be turned is of a size other than that for which a suitable and available socket wrench or other such tool is designed for, the adjustment may not be possible. Since many operators often drive many different models of trucks utilizing slack adjusters with different adjusting nut sizes, the operator will need to purchase and carry additional wrenches or sockets of different sizes to ensure the suitable tool is available when needed.

In addition to periodic air brake slack adjustment checks, a common preventive measure taken by many heavy truck operators, particularly those pulling semi trailers having many sets of tires, or other operators driving long distances or with very heavy loads, is checking the tires for conditions of insufficient air pressure or deflation. This is of particular importance to operators of semi trailers having dual wheels mounted on one axis, as a flat or insufficiently inflated tire, supported on the ground surface by the adjacent properly inflated tire, may not be visibly noted by the operator. To check the tire for the presence of air pressure, an operator, using a weighted tool commonly known in the art having an impact surface and grasping area, impacts the outer surface of the tire similarly to using a hammer, noting the amount of tension and bouncing of the impact surface. The amount of tension and bouncing thereupon indicates whether the tire is in a low pressure or deflated condition, requiring maintenance. Such a tool, while providing the necessary means for checking inflation of a tire, is somewhat large and heavy due to the attributes of the tool required for providing sufficient striking force, and adds significantly to an operator's tool kit in weight and volume, undesirable for those who perform many such maintenance operations or for four those often performing roadside maintenance.

What is clearly needed is an improved tool for ascertaining and adjusting slack within a rocker arm assembly in an air brake assembly that combines, within one tool, the additional functions of separate tools required for performing said slack adjustments in various truck models, and for checking the degree of inflation in a tire. Such an improved tool must be easy to use, of sturdy construction and be economical to manufacture and substantially maintenance-free. Greater efficiency is afforded to a user performing the described maintenance with such a tool by eliminating the need to carry and maintain a set of several tools suitable for every brake adjustment and tire check situation, improving preparedness while saving much time, inconvenience and expense.

### SUMMARY OF THE INVENTION

In a preferred embodiment of the present invention, a tool for measuring and adjusting slack movement related to operating components of an air-brake assembly is provided. The tool comprises, an elongated lever portion of the tool for enabling leverage force to be applied to a rocker-arm component of the air-brake assembly, the lever portion having a first and second end, a width dimension and a thickness dimension, the width dimension substantially greater than the thickness dimension, an abutment fixture fixedly attached to the first end of the lever portion, the abutment fixture protruding from the lever portion at a stated angle from a first longitudinal edge defining the thickness dimension of the lever portion, the abutment fixture providing a fulcrum point against the rocker-arm component for application of leverage force; an engaging member fixedly attached to the first end of the lever portion at a point substantially inward from the attachment position of the abutment fixture, the engaging member for engaging the rocker-arm component on an edge of the rocker-arm component opposite an edge engaged by the abutment fixture, the engaging member protruding from the first longitudinal edge of the lever portion at substantially the same angle and direction as the abutment fixture; and a socket mount fixedly attached to the second end of the lever portion at a position substantially inward of the outer edge of the second end, the socket mount protruding from a third longitudinal edge defining the width dimension of the lever portion, the socket mount comprising a socket for fitted engagement of a slack-adjustment nut of the air brake assembly. A user operating the tool may measure and adjust slack in the air-brake assembly without requiring use of more than one disparate tool.

In a preferred embodiment, the material used to manufacture the tool is steel. In one aspect, the method of manufacture of the lever portion is die-cast. In another aspect, the abutment fixture, the engaging member, and the socket mount are fixedly attached by welding.

In one aspect, the tool further comprises, an elongated impact head fixedly attached to the first end of the lever portion at a point substantially near the attachment point of the abutment fixture and on a second longitudinal edge defining the thickness dimension of the lever portion, the impact head protruding from the second longitudinal edge at a stated angle and in a direction substantially opposed to the direction of protrusion of the abutment fixture and the engaging member, the impact head for striking tires resulting in a determination of proper tire inflation. In one aspect, the impact head is fixedly attached by welding.

In another aspect, the tool further comprises a plurality of inserted socket assemblies, the assemblies inserted into individual ones of a plurality of openings extending through the thickness dimension of the lever portion and located at the second end of the lever portion at spaced positions substantially outward from the attachment position of the socket mount. The inserted socket assemblies are oriented substantially perpendicular to the longitudinal edges defining the width dimension of the lever portion. The socket assemblies are for fitted engagement to alternate slack-adjusting nuts, which may be present on an air-brake assembly.

In one aspect, the socket assemblies are removable and interchangeable with other socket assemblies. In this aspect, the socket mount also accepts a variety of sockets having different dimensions. Also in one aspect, the socket assemblies comprise sockets having geometric constructions different from each other.

In another aspect of the present invention, a method for measuring and adjusting slack movement related to operating components of an air brake assembly using a single tool is provided. The tool comprises, an abutment fixture attached thereto for providing a fulcrum point for focusing leverage, the leverage applied against a rocker-arm component of the air brake assembly and an engaging member attached thereto for engaging the rocker-arm component on a side opposite the abutment side engagement point, the engagement and abutment facilitating leveraged movement of the rocker-arm component. The method comprises the steps of, (a) positioning the tool against the rocket-arm component so as to engage the assembly for application of leveraged movement of the component, (b) applying levered force to the rocket-arm component using the tool as a lever to pull the piston-end of the component away from the piston cylinder of the air-brake assembly, (c) determining the amount of slack existing in the air-brake assembly by judging amount of movement against an acceptable standard, (d) upon finding adjustment necessary, removing the tool from its position against the rocker-arm component, (e) reversing the hand-held position of the tool in order to engage the slack-adjustment nut of the air-brake assembly with the socket-end of the tool, (f) engaging the socket portion of the tool over the slack-adjustment nut; and (g) adjusting the slack in the airbrake assembly by turning the slack-adjustment nut.

In all aspects of the method in step (a) the abutment fixture and engaging member of the tool provide the architecture for securing and leveraging the rocker-arm component. In another aspect, the tool further comprises, an elongated impact head for striking tires to determine inflation state of the tires. In this aspect of the method, steps are added as follows, (h) reversing the hand-held position of the tool after slack-adjustment in order to engage the impact-head of the tool against the surfaces of the tires and (i) striking the tires with the impact-head of the tool to determine inflation state.

Now, for the first time, an improved tool for ascertaining and adjusting slack within a rocker arm assembly in an air brake assembly that combines, within one tool, the additional functions of separate tools required for performing said slack adjustments in various truck models, and for checking the degree of inflation in a tire is provided. Such an improved tool is easy to use, of sturdy construction and is economical to manufacture and substantially maintenance-free. Greater efficiency is afforded to a user performing the described maintenance with such a tool by eliminating the need to carry and maintain a set of several tools suitable for every brake adjustment and tire check situation, improving preparedness while saving much time, inconvenience and expense.

### BRIEF DESCRIPTION OF THE DRAWING FIGURES

FIG. 1 is an elevation view of a brake slack-adjusting tool according to a preferred embodiment of the present invention.

FIG. 2 is an elevation view of the brake slack-adjusting tool of FIG. 1 rotated 90 degrees.

FIG. 3 is a top end view of the brake slack-adjusting tool of FIG. 1.

FIG. 4 is a perspective view of the brake slack-adjusting tool of FIG.

FIG. 5 is a side elevation view of the brake slack-adjusting tool of FIG. 1 illustrating attachment to a rocker arm assembly of a common air brake assembly.

FIG. 6 is a side elevation view of the components of FIG. 5 illustrating a method step on pivoting the rocker arm assembly to measure slack within the air brake assembly.

FIG. 7 is a side elevation view of the components of FIG. 5 illustrating a method step on actuating an adjustment mechanism within the rocker arm assembly to adjust slack within the air brake assembly.

### DESCRIPTION OF THE PREFERRED EMBODIMENTS

As previously mentioned in the background section, it is of great importance to the operator of a heavy truck or truck tractor pulling a trailer or semi trailer with many sets of tires, to be prepared with the proper tool in the event a brake slack adjustment or tire pressure check is necessary. Many well-known tools currently exist in the art, tools designed for the specific functions such as pry-bar type tools for engaging and moving an air brake rocker arm to check slack in the system, various wrenches for rocker arm slack adjustment, and striking tools for tire pressure assessment. To be properly prepared, a heavy truck operator or mechanic must handily maintain all of the proper tools whether in a shop environment or while traveling on the road. Due to the increased demand caused by heavy loads and increased use as compared to many other smaller braking systems, the components of an air brake system, particularly the brake shoes in an internally-expanding drum type system as described, experience increased wear requiring periodic adjustment at increased intervals. Improperly adjusted air brakes pose a particular danger for heavy trucks traveling long downgrades where it is often necessary for an operator to continually apply the brakes to curtail excessive and unsafe speed. If the slack condition of an air brake system is suspect prior to a truck operator beginning to drive such a downgrade, or for preventive safety reasons at any time, the operator will be required to exit the vehicle obtaining the required tools for the procedure, and, with tools in hand and finding a position beneath the vehicle or trailer near the air brake rocker arm, then perform the assessment and adjustment of the brake slack, if any. If the correct and suitable tool for the particular brake slack adjustment to be performed is not readily available, a great inconvenience and possibly an abortion of the procedure is the result.

For safety reasons is also necessary for an operator, particularly when operating a truck tractor pulling a semi trailer having several sets of tires mounted adjacently, to periodically check the tires for sufficient air pressure, especially those that are obscured from obvious vision by the adjacently mounted outer tire of the set. In many cases the procedures of checking air brake slack and tire pressure are performed during the same period while the truck is stopped. In this case the operator would desire to have the suitable tool for all functions involved in these procedures in hand or conveniently located nearby, avoiding return trips to the tool storage area for tools not obtained beforehand. The present invention for the first time provides a solution to problems presented with maintaining a set of multiple tools required for procedures involved with air brake system and tire maintenance as previously described, and is taught in further enabling detail.

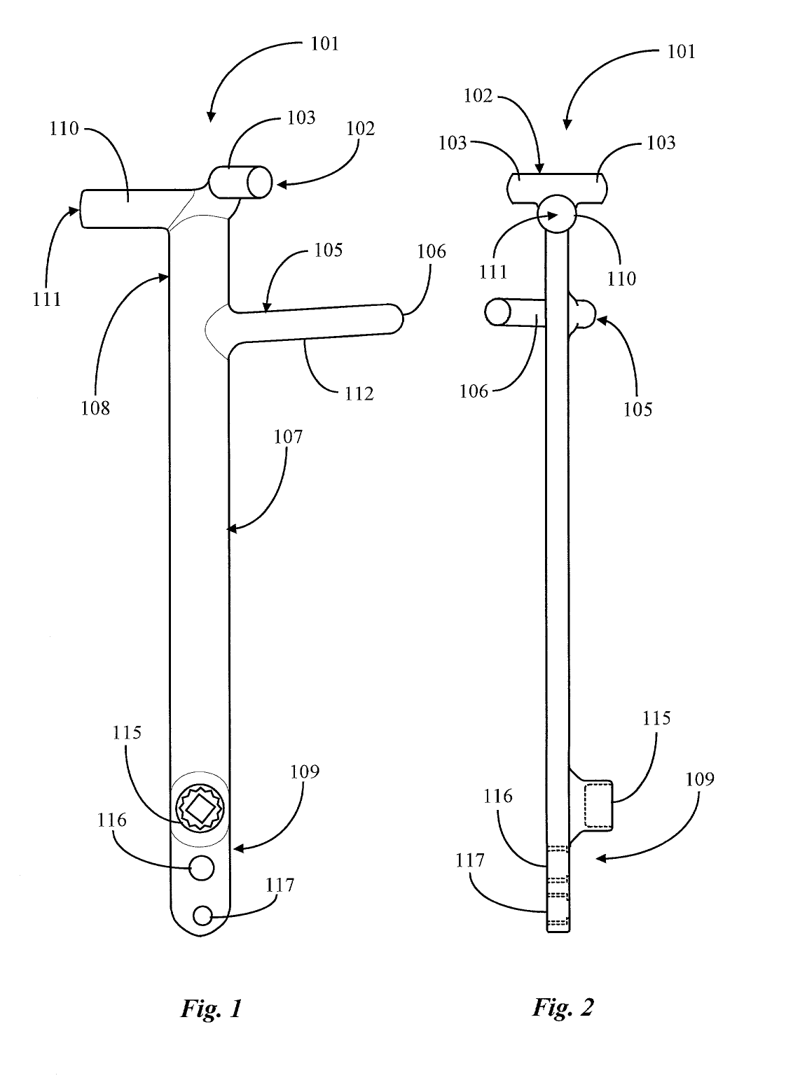

FIG. 1 is an elevation view of a brake slack-adjusting tool according to a preferred embodiment of the present invention. Tool 101 combines the capabilities of separate tools required to perform actions necessary for checking and adjusting slack within an air brake system, as well as for checking the approximate degree of air pressure within a tire. Tool 101 is comprised of heavy steel or some other similarly strong, sturdy metal can be manufactured utilizing a variety of methods such as forging, casting and so on. Tool support section 107, providing the main structural support, is also the main body and in this example is of a rectangular bar-like shape much wider than its thickness, a design intended to provide increased strength and support when leveraged in the intentional direction during operation. A brace 102, only partially seen in this view, is welded to the top of an upper section 108 and consists of a pair of arms 103, only one being visible here, each cylindrical in shape and joining at a center point forming an angle of approximately 90 degrees. Upper section 108 has a connector hook 105, also of a cylindrical shape and circumference similar to arms 103, having a central body section 112 extending outward to an arcuate outer actuator section 106. The circular hooked end of the outer actuator section 106, integral with central body section 112, is made clearly visible in subsequent drawings. Connector hook 105 in this embodiment is welded to the forward edge of upper section 108, and positioned at a distance below brace 102 such that when engaged upon the primary rocker arm of an air brake system, as will also be subsequently detailed, the preferred leverage and fit upon the rocker arm is achieved. Central body section 112 of hook 105 is of a length providing the proper spacing for such placement and leverage.

Impact head 110 is cylindrical in shape having a solid core comprising the same material used to manufacture tool 101, is approximately 1½ inches in length and of a circumference slightly greater than that of arms 103 or hook 105. Impact head 110 has an impact surface 111 with which contact is made with the outer edge of a tire when it is impacted during a tire pressure check using processes well known. Impact head 110 has sufficient mass and weight to enable the user to exert the striking force necessary to provide an interpretable bounce when impacting a tire, without compromising the overall balance of the tool. Impact head 110 in this embodiment is located at the top of upper section 108, welded at its base onto upper section 108 directly behind of and extending rearward to arms 103.

At the lower section of support section 107, a socket section 109 is provided having a main socket 115 which can be of a standard type similar to that used with a socket wrench, and is of a standard size equaling that of adjusting nuts used in the air brake rocker arms in the majority of vehicles so equipped. Socket 115 is welded integrally into socket section 109, and may or may not pass completely through its thickness. Also positioned within socket section 109 and attached by welding similarly to socket 115, are additional sockets 116 and 117 positioned in line directly below socket 115. Sockets 116 and 117 are provided in this embodiment to be used similarly to socket 115 for the purpose of turning an adjusting nut any brake slack adjusting system. Socket 117 is slightly smaller in diameter than socket 116, and both are of sizes equaling those of adjusting nuts of air brake slack adjusting systems found in some other models of trucks.

It is one purpose of the design according to a preferred embodiment for socket section 109 to have, integrally welded within, a combination of sockets all being of different size but collectively providing the user with the correct size socket for a majority of different model air brake slack adjusters. In alternative embodiments of the present invention, the sockets in socket section 109 can vary in size and number, and can be designed for use on different adjusters other than standard hexagonal nuts such as described. For example, one embodiment may have a set of sockets of standard size used in one region where that is the standard, while an alternative embodiment may have a set of sockets in metric size for use in another region with different size standards. Or a combination of metric and standard sizes may be used for the sockets of another alternative embodiment.

In still another embodiment, socket section 109 may have openings provided therein and adapted for the purpose of accepting press-fitted sockets wherein the sockets themselves are removable and interchangeable with sockets of varying geometric construction for fitting different adjustment nuts that may be present in an air-brake assembly. Likewise, instead of main socket 115 being welded in un-removable fashion to socket section 109, a socket mount capable of accepting a variety of sockets may be provided and fixedly attached to section 109 such as by welding. In this embodiment, a user may attach and detach applicable sockets.

FIG. 2 is an elevation view of brake slack adjusting tool 101 of FIG. 1, rotated 90 degrees. The back of tool 101 is now plainly visible illustrating the thickness of the body of tool 101. Both arms 103 of brace 102 can also be seen extending outward from each other. Impact surface 111 of impact head 110 is now clearly seen illustrating the rounded cylindrical shape of impact head 110. The cylindrical shape of connector hook 105 is also apparent in this view, and the width of arcuate outer actuator section 106 of hook 105 is illustrated as well, a width providing the proper spacing to be compatible with air brake rocker arms around which hook 105 will be placed when positioned in use. Socket 115 is seen welded into the side of socket section 109, extending outward to a length providing a socket cavity with sufficient depth to firmly grasp an adjusting nut without slippage. Smaller sockets 116 and 117 are also seen positioned directly below socket 115, and can be seen passing completely through the thickness of handle section 109 so as to be able to provide a firm grasp upon alternative adjusting nuts having dimensions higher than the thickness of socket section 109, for example.

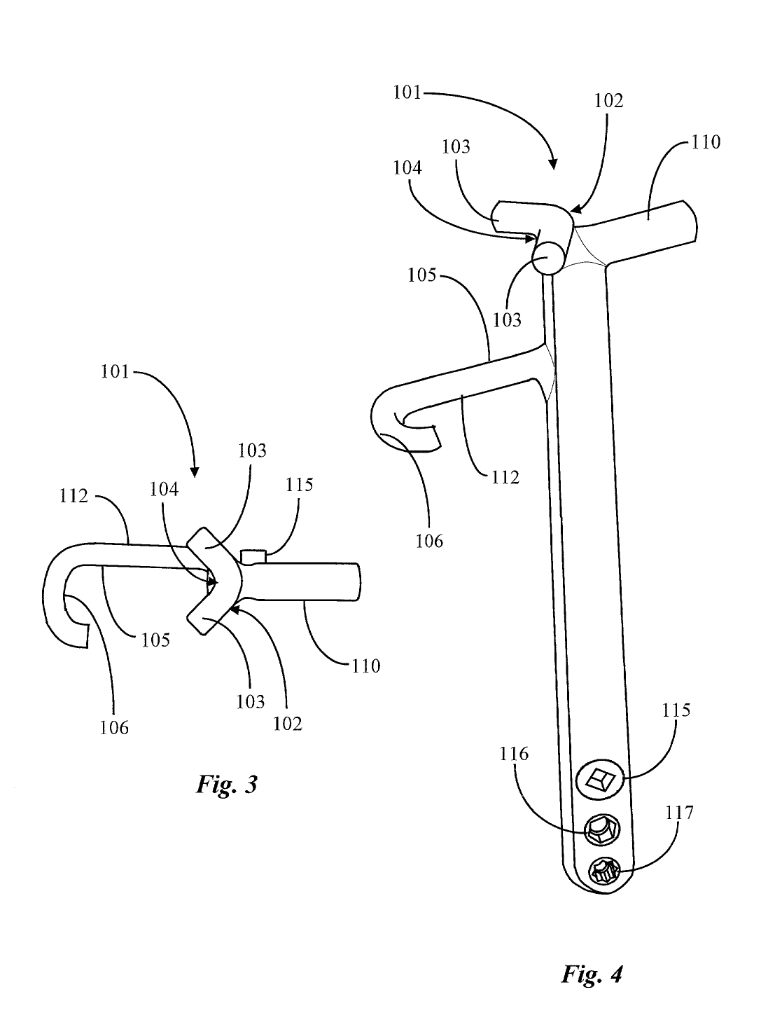

FIG. 3 is a top end view of brake slack adjusting tool 101 of FIG. 1. The angle formed by the cylindrical arms 103 of brace 102, an angle of approximately 90 degrees, is now apparent, and at the central meeting point of arms 103 a notch 104 is formed. The circular shape of outer actuator section 106 and the straight central body section 112 of connector hook 105 are plainly visible in this view. The tip of socket 115 can be seen illustrating its outward dimension in relation to other elements, an impact head 110 is shown extending back from brace 102.

FIG. 4 is a perspective view of brake slack adjusting tool 101 of FIG. 1, further clearly illustrating the various elements of the tool in a preferred embodiment. The dimensions, positioning and spacing of the elements such as arms 103 of brace 102 which form notch 104, central body section 112 and outer actuator section 106 of connector of 105 as well as sockets 115, 116, 117 will become apparent in later descriptions.

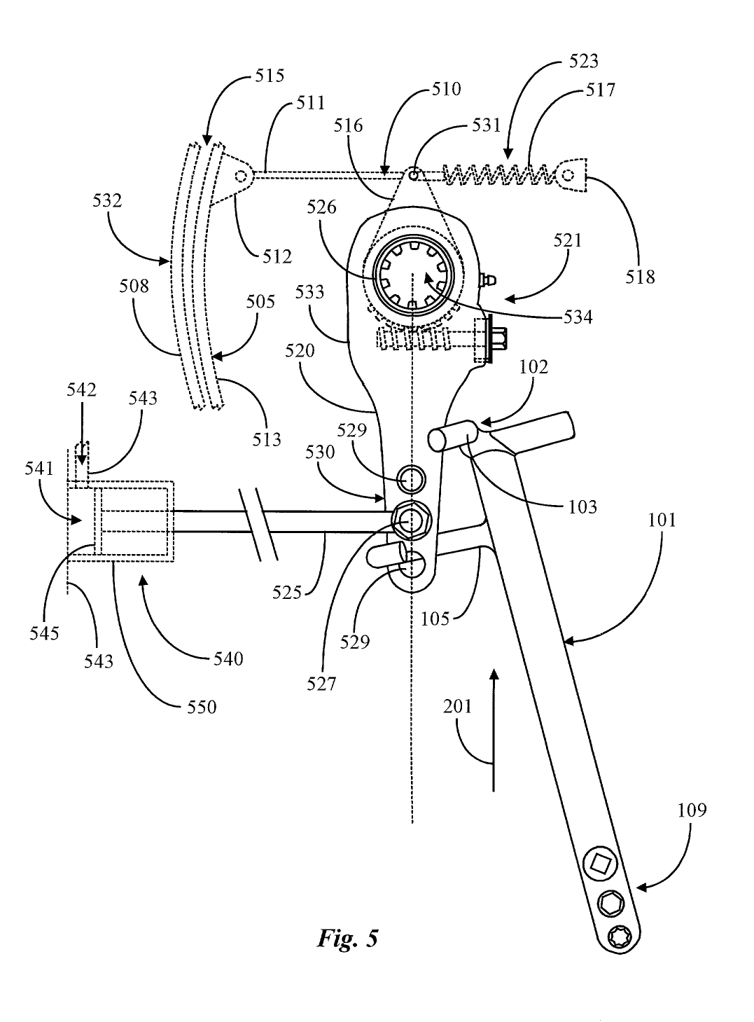

FIG. 5 is a side elevation view of brake slack adjusting tool 101 of FIG. 1 illustrating attachment to a rocker arm assembly of a common air brake assembly. Air brake assembly 521, shown here depicting only those elements key to, or otherwise affected by brake slack adjustment, is representative of a typical air brake system well known in the art. Many details not pertinent or unrelated to objects of the present invention have been omitted for reasons of clarity, as the main purpose for showing such a system is to illustrate the placement and operation of the tool of the present invention. Air brake assembly 521 includes a brake shoe assembly 505 mounted within a respective rotatable wheel member 532. A rocker arm assembly 533 is operably connected to brake shoe assembly 505 for actuation thereof, and an air actuator assembly 540 operable under air pressure to rotate the rocker arm assembly 533, which in turn, activates a braking operation with movement of the brake shoe assembly 505. Brake shoe assembly 505 includes a brake drum 508 supporting an outer rotatable wheel member 532, a brake shoe 513 that is outwardly movable in order to provide contact with brake drum 508 when the brakes are actuated, and a brake actuator arm assembly 510 that is interconnected between brake shoe 513 and rocker arm assembly 533. When the brakes are not actuated a space 515 exists between the outer edge of brake shoe 513 and the inner wall of brake drum 508, the space that diminishes and increases as the brakes are actuated and released. Brake shoe assembly 505 also includes a connector lug 512 for attachment to brake actuator arm assembly 510. Brake actuator arm assembly 510 has a connector rod 511 with one end connected to connector lug 512 and the other end connected to rocker arm assembly 533 and to a tension assembly 523 using a common connection. Tension assembly 523 has a spring 517 with one end connected to a common connection of connector rod 511 and rocker arm assembly 533, and having an outer and connected to an anchor lug 518 which is secured to a non-movable portion of air brake assembly 521.

Rocker arm assembly 533 has a primary rocker arm 520 operably connected by a shaft to a secondary rocker arm 516. Primary rocker arm 520 has a shaft opening 534 and a connector section 530 that is of a tapered shape having three evenly spaced adjustment holes. Secondary rocker arm 516 is connected to rocker arm assembly 533 and has a shaft connector hole 526, and also has an upper connector hole 531 connected to an inner end of connector rod 511 and an outer and of 517. The shaft connector hole 526 of secondary rocker arm 516 and shaft opening 534 of primary rocker arm 533 per shown in this view as having a spline connection portion providing conjoint rotation about the central axis of a connecting shaft (not shown). The operation thereof with this configuration is such that rotational movement of the primary rocker arm assembly 533 conjointly rotates secondary rocker arm 516 which in turn causes outward movement of brake shoe 513 against brake drum 508, typical of a conventional air brake operation.

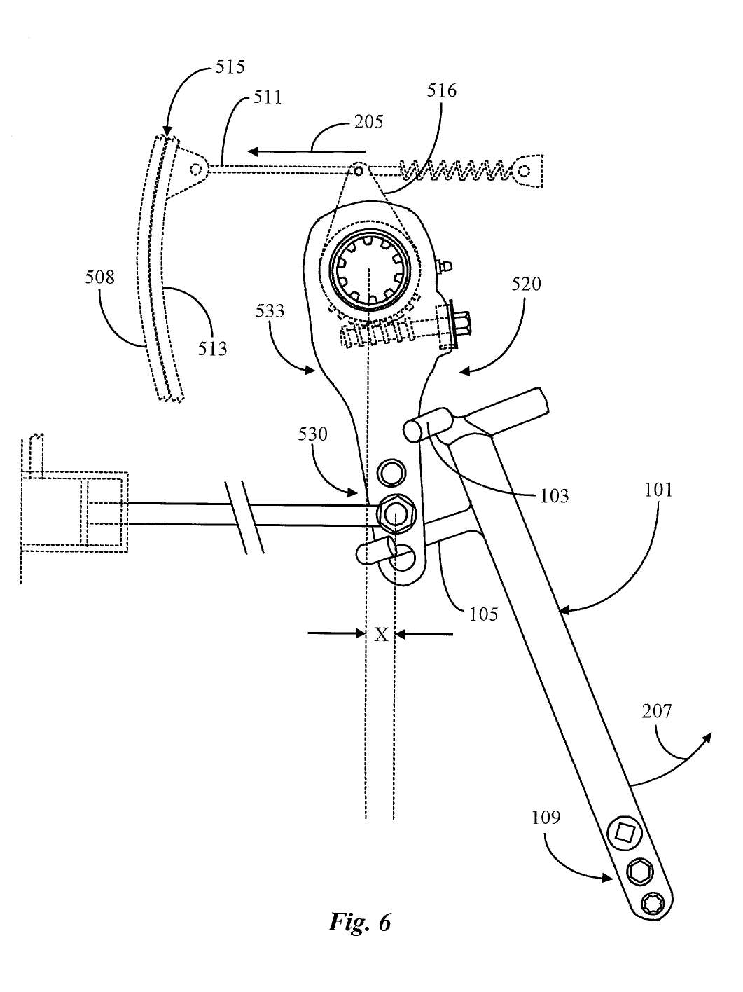

Air actuator assembly 540 is shown in this greatly simplified view attached to a support wall 543 and additionally attached to connector section 530 of primary rocker arm 520 so that when air pressure is applied on actuation of a brake pedal by the truck operator movement is applied to primary rocker arm 520. Air actuator assembly 540 comprises of a cylinder 550 connected to support wall 543 with an internal piston 545, ultimately connected utilizing various hardware elements not shown, to one end of an actuator rod 525, with the other end of actuator rod 525 connected using a standard connector 527 through the center connector hole 529 of connector section 530 of primary rocker arm 520. The various hardware mentioned may also include threaded end sections providing a level of adjustability to the connection provided between piston 545 and primary rocker arm 520. Piston 545 within cylinder 550 is actuated by a connection through a fluid actuator source 542 supplying air pressure to space 541 behind piston 545 upon application of a brake pedal or lever by the operator. Reciprocal piston 545 is connected to actuator rod 525 providing conjoint movement when brakes are applied, and is selectively movable under air pressure received from the fluid actuator source 542 having an inlet line 544 through which air pressure is applied for movement to an extended position as noted in FIG. 6.

One of the purposes and functions of brake slack adjusting tool 101 it is to measure slack movement of rocker arm assembly 533 when brakes are not being applied. Brake slack adjusting tool 101 is shown in this view illustrating proper attachment to air brake assembly 521 when preparing to measure slack movement of rocker arm assembly 533, as further illustrated and indicated by the letter “X” in FIG. 6. This slack movement indicates spacing between brake drum 508 and the non-actuated brake shoe 513, as indicated by element 515. In this view tool 101 is extended inward towards rocker arm assembly 533 in the direction indicated by arrow 201 until reaching the proper condition as indicated, with the notch formed by arms 103 of brace 102 against the outer upward portion of connector section 530 of primary rocker arm 520. Arms 103 are operable to maintain the abutting portion of primary rocker arm 520 between the arms 103. Once arms 103 are positioned on connector section 530 of primary rocker arm 520, the operator can then, by grasping socket section 109 to be used in this operation as a handle, and moving tool 101 further in the direction of arrow 201 until connector hook 105 of tool 101 engages the edge of connector section 530 opposite the edge now engaged by arms 103.

FIG. 6 is a side elevation view of the components of FIG. 5 illustrating a method step on pivoting the rocker arm assembly to measure slack within the air brake assembly. With brake slack adjusting tool 101 now properly positioned upon primary rocker arm 520 with arms 103 and connector hook 105 securely holding the tapered connector section 530 by both edges, the operator can then, through grasping socket section 109 as a handle, pivot the entire brake slack adjusting tool 101 as noted by an arrow 207, conjointly providing movement to primary rocker arm 520 in the same direction, forcing secondary rocker arm 516 and connector rod 511 in the direction of arrow 205, until contact is made between brake shoe 513 and brake drum 508, eliminating space 515. This movement will then reveal a slack condition within the rocker arm assembly 533 as indicated by letter “X”. If the movement indicated by letter “X” is within acceptable standards set forth the air brake assembly 521 is in satisfactory condition and does not require a slack adjustment. If a slack adjustment is required it can be performed using novel functions incorporated into brake slack adjusting tool 101 for this purpose as is described below. The brake slack assessment procedure described is repeated by the operator to check all of the air brake assemblies 521 existing on the vehicle by repeating the aforementioned steps.

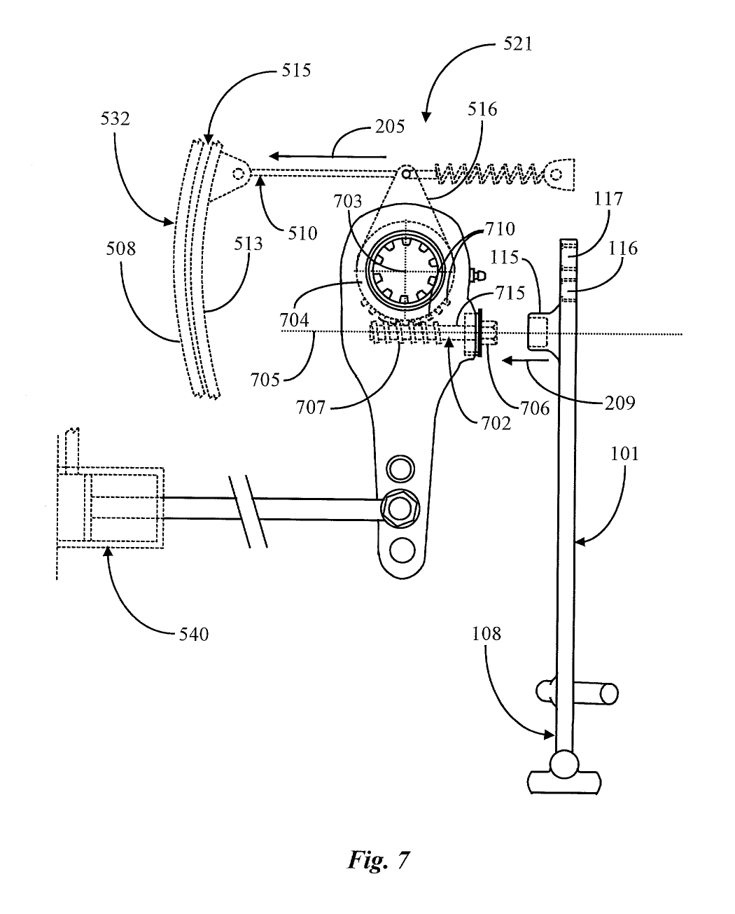

FIG. 7 is a side elevation view of the components of FIG. 5 illustrating a method of actuating an adjustment mechanism within the rocker arm assembly to adjust slack within the air brake assembly. Air brake assembly 521 is assumed in this illustration to be in a condition of having an amount of slack that is beyond a measurable amount considered safe, thus requiring a slack adjustment. Another purpose and function of brake slack adjusting tool 101 according to a preferred embodiment of the present invention is to provide a means for manually adjusting said slack, a procedure described in further enabling detail. It is shown in this view that air actuator assembly 540 is in a relaxed, non-actuated position, with the object of this step being to diminished the space 515 between brake shoe 513 and brake drum 508, a space that equates to the excess slack condition mentioned. Slack adjusting mechanism 702 is shown in this view with many details not pertinent to the object of the invention omitted for reasons of clarity. Secondary rocker arm 516 is attached to a brake operating shaft 703, conjointly pivotal around the rotation axis of brake operating shaft 703 by means of an operating member. Slack adjusting mechanism 702 comprises a worm gear coupling having a worm gear extension 715 attached to external adjusting nut 706, pivotal around the rotation axis of worm gear extension 715 as referenced by axis line 705. Worm 707 exhibits extensions that engage teeth 710 of a gear wheel 704, which is attached and rotates conjointly with brake operating shaft 703. By manually turning adjusting nut 706 movement is provided to gear wheel 704 which in turn rotates brake operating shaft 703, conjointly rotating secondary rocker arm 516. A clockwise rotation of adjusting nut 706 in this example thereby moves actuator arm assembly 510 in the direction indicated by arrow 205 and forces connected brake shoe 513 in the direction of brake drum 508 of wheel member 532, decreasing space 515 and thereby reducing the degree of slack within air brake assembly 521. To accomplish manual turning of adjusting nut 706 the operator will hold brake slack adjusting tool 101 inverted, aligning the center axis of socket 115 with that of worm gear extension 715. Tool 101 is held in this position by grasping section 108 and is moved into position in the direction indicated by arrow 209 until socket 115 covers and fits over adjusting that 706. Tool 101 is then rotated around axis 705, turning adjusting nut 706 likewise in a manner similar to using a standard socket wrench. If a sufficient amount of slack is not removed by this first operation, socket 115 of tool 101 is removed from adjusting nut 706, repositioned at a new angle to allow for another turn and the procedure is repeated until the excess slack has been removed. Sockets 116 and 117 of tool 101 are used similarly as socket 115 to turn adjusting nuts of different sizes on varying models of air brake assemblies, with the exception that tool 101 is flipped horizontally while still being held by the operator at section 108, in order to allow sockets 116 or 117 to completely cover the different sizes of adjusting nut. As mentioned previously alternative embodiments of the present invention may have sockets varying in size, number and type dependent upon the specific requirements of the operator and different models of air brake systems requiring adjustment.

Brake slack adjusting tool 101 further serves as a means for testing air pressure within a tire such as would be attached to wheel member 532 of previous figures. Referring now to FIG. 4 and the perspective view of brake slack adjusting tool 101, impact head 110 is designed into the preferred embodiment as previously described providing a striking implement, to be used similarly to a hammer, to impact the outer surface of a tire so as to gauge the tension and bounce of the rebound to determine whether the tire is in a low air pressure or deflated condition. Such a procedure is commonly known in the art and other conventional well-known impact tools exist for this purpose. For the first time a preferred embodiment of the present invention, as described herein, novelly combines the tire testing function with the functions of a slack testing tool and a slack adjusting tool.

By utilizing such an improved tool that combines these multiple functions, greater efficiency is afforded to the user by eliminating the need to carry and maintain a set of several tools suitable for every brake adjustment and tire check situation, improving preparedness while saving much time, inconvenience and expense. Such an improved tool is easy to use, of sturdy construction and is economical to manufacture and substantially maintenance-free. It will be apparent to one with ordinary skill that the method and apparatus of the present invention may be practiced in many different types of air brake assemblies and used to check tire pressure on many different types and sizes of tires, and therefore may be slightly modified in dimensional size and shape to fit varying situations without departing from the main objects of the invention. It will also be understood that, although the present invention has been described in conjunction with preferred specific embodiments thereof, the description is intended to illustrate and not to limit the scope of the invention. For these reasons the method and apparatus of the present invention should be afforded the broadest possible scope limited only by the claims that follow.

What is claimed is:

1. A tool for measuring and adjusting slack movement related to operating components of an air-brake assembly comprising:
an elongated lever portion of the tool for enabling leverage force to be applied to a rocker-arm component of the air-brake assembly, the lever portion having a first and second end, a width dimension and a thickness dimension, the width dimension substantially greater than the thickness dimension;
an abutment fixture fixedly attached to the first end of the lever portion, the abutment fixture protruding from the lever portion at a stated angle from a first longitudinal edge defining the thickness dimension of the lever portion, the abutment fixture providing a fulcrum point against the rocker-arm component for application of leverage force;
an engaging member fixedly attached to the first end of the lever portion at a point substantially inward from the attachment position of the abutment fixture, the engaging member for engaging the rocker-arm component on an edge of the rocker-arm component opposite an edge engaged by the abutment fixture, the engaging member protruding from the first longitudinal edge of the lever portion at substantially the same angle and direction as the abutment fixture; and
a socket mount fixedly attached to the second end of the lever portion at a position substantially inward of the outer edge of the second end, the socket mount protruding from a third longitudinal edge defining the width dimension of the lever portion, the socket mount comprising a socket for fitted engagement of a slack-adjustment nut of the air brake assembly, characterized in that a user operating the tool may measure and adjust slack in the air-brake assembly without requiring use of more than one disparate tool.

2. The tool of claim 1, wherein the material used to manufacture the tool is steel.

3. The tool of claim 2, wherein the method of manufacture of the lever portion is die-cast.

4. The tool of claim 3, wherein the abutment fixture, the engaging member, and the socket mount are fixedly attached by welding.

5. The tool of claim 3 further comprising an elongated impact head fixedly attached to the first end of the lever portion at a point substantially near the attachment point of the abutment fixture and on a second longitudinal edge defining the thickness dimension of the lever portion, the impact head protruding from the second longitudinal edge at a stated angle and in a direction substantially opposed to the direction of protrusion of the abutment fixture and the engaging member, the impact head for striking tires resulting in a determination of proper tire inflation.

6. The tool of claim 5, wherein the impact head is fixedly attached by welding.

7. The tool of claim 6 further comprising a plurality of inserted socket assemblies, the assemblies inserted into individual ones of a plurality of openings extending through the thickness dimension of the lever portion and located at the second end of the lever portion at spaced positions substantially outward from the attachment position of the socket mount, the inserted socket assemblies oriented substantially perpendicular to the longitudinal edges defining the width dimension of the lever portion, the socket assemblies for fitted engagement to alternate slack-adjusting nuts, which may be present on an air-brake assembly.

8. The tool of claim 7, wherein the socket assemblies are removable and interchangeable with other socket assemblies.

9. The tool of claim 8, wherein the socket mount accepts a variety of sockets having different dimensions.

10. The tool of claim 9, wherein the socket assemblies comprise sockets having geometric constructions different from each other.

11. A method for measuring and adjusting slack movement related to operating components of an air brake assembly using a single tool, the tool comprising:
an abutment fixture attached thereto for providing a fulcrum point for focusing leverage, the leverage applied against a rocker-arm component of the air brake assembly; and
an engaging member attached thereto for engaging the rocker-arm component on a side opposite the abutment side engagement point the engagement and abutment facilitating leveraged movement of the rocker-arm component; the method comprising the steps of:
(a) positioning the tool against the rocket-arm component so as to engage the assembly for application of leveraged movement of the component;
(b) applying levered force to the rocket-arm component using the tool as a lever to pull the piston-end of the component away from the piston cylinder of the air-brake assembly;
(c) determining the amount of slack existing in the air-brake assembly by judging amount of movement against an acceptable standard;
(d) upon finding adjustment necessary, removing the tool from its position against the rocker-arm component;
(e) reversing the hand-held position of the tool in order to engage the slack-adjustment nut of the air-brake assembly with the socket-end of the tool;
(f) engaging the socket portion of the tool over the slack-adjustment nut; and,
(g) adjusting the slack in the air-brake assembly by turning the slack-adjustment nut.

12. The method of claim 11 wherein in step (a) the abutment fixture and engaging member of the tool provide the architecture for securing and leveraging the rocker-arm component.

13. The method of claim 12 wherein the tool further comprises:
an elongated impact head for striking tires to determine inflation state of the tires.

14. The method of claim 13 wherein steps are added as follows:
(h) reversing the hand-held position of the tool after slack-adjustment in order to engage the impact-head of the tool against the surfaces of the tires; and
(i) striking the tires with the impact-head of the tool to determine inflation state.
